(19) United States
(12) Patent Application Publication
(10) Pub. No.: US 2015/0343467 A1
(43) Pub. Date: Dec. 3, 2015

(54) GARDENING SPRY GUN

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., CHANGHUA (TW)

(21) Appl. No.: 14/293,259

(22) Filed: Jun. 2, 2014

(51) Int. Cl. B05B 9/01

(52) U.S. Cl. CPC B05B 9/01

(57) ABSTRACT

A gardening spray gun may include a main body, a shaft, a retaining buckle, and a control unit. In one embodiment, the control unit is connected with the shaft, so the water coutput can be continuously maintained out without keeping a constant pressure on the spray gun, which saves the gardener's energy, effectively reduces the hand burden, and maintains a stable water outflow volume each and every time. The water spray gun in the present invention can be easily assembled by putting the shaft, the retaining buckle and the control unit together.

### FIELD OF THE INVENTION

This invention relates to a gardening spray gun, and more particularly to a gardening spray gun with a connecting block that can be used to control the water flow.

### BACKGROUND OF THE INVENTION

In order to prevent plants from drying out because of water shortage, watering the plants frequently is necessary. When a range of plants is grown broader or far from water sources, extension on hoses in the process of watering is normally a general solution. However, the water pressure may be too high to spray out directly from the pipes, which may kill the plants. Furthermore, the watering area may be too small and the duration of watering may be too long with the extended hoses. Therefore, gardeners are currently using spraying gun so the water can reach a broader area to increase the efficiency.

Most conventional water spraying guns are equipped with a controller at the handle. By holding the handle and operating the controller, the user can control the water flow. When the user releases the controller, the handle or bottom immediately swings back to seal the outflow entrance to keep water from spraying out any further. However, with this hand-held press control, water outflow cannot be maintained in a certain amount each and every time. Due to same gesture and certain pressure must the gardener maintained firmly by hand or fingers for a long time, tiredness and soreness may occur. In addition, most of the existing conventional water spray guns are limited with a certain kind of design on buttons, or the control object, which may result in sudden reduction on waterways, and unable to reach large volume of water outflow, causing inconvenience to gardeners. Therefore, there remains a need for a new and improved gardening spray gun structure to overcome the problems stated above.

### SUMMARY OF THE INVENTION

In the present invention, a gardening spray gun may include a main body, a shaft, a retaining buckle, and a control unit. The main body has a handle, and a barrel portion which connects with the handle. The handle is covered with a protection cover. With an anti-leaking unit in between the handle and barrel portion, the handle and barrel portion can be brought together tightly to achieve an anti-leaking effect. At a front end of the barrel portion, there is a water flowing hole located at one side of a sprinkler base connected to a sprinkler head. The handle has a water control space located at a top corner thereof, and the water control space is communicated with an inlet conduit of the handle, an outlet conduit of the barrel portion, and the water flowing hole of the sprinkler base. A curved guiding surface is formed at outer periphery of the water control space and both side of the guiding surface has a retaining rib. On the sprinkler head, there are sprinkler holes used to control of water flow in various manners. There is a positioning device with a spring and a pillar located between the sprinkler base and sprinkler head.

There is a drainage port located at a side corner of a shaft with a suitable angle. A water through hole is located at the bottom of the drainage port, going through other opposite side through the shaft. When the water through hole is shaded with different degrees, it can be utilized to control water flow and turn the water on or off. A sealing ring covered onto a ring groove is located on one side of the shaft, and a smaller joint tube is extending toward the other side thereof. The ring groove is extending outwardly connected with a stopping edge, and a block protrudes out from both sides of the stopping edge. In one embodiment, the joint tube is non-circular.

A retaining buckle has an enlarged ledge at one end, a connecting hole shaped similar as the joint tube located at the other end. A stopping block are protrudingly formed at an inner surface on both sides of the enlarged ledge. A sealing ring covered onto a ring groove is located outside of the retaining buckle. The control unit has two spiral arms and a connecting block located in between. There is a ladder-shaped hole located at the spiral arm, and a engaging slot is recessedly formed in the ladder-shaped hole.

Comparing with conventional arts, the present invention is advantageous because (i) the control unit is connected with the shaft, so the water coutput can be continuously maintained out without keeping a constant pressure on the spray gun, which saves the gardener's energy, effectively reduces the hand burden, and maintains a stable water outflow volume each and every time; (ii) the water spray gun can be easily assembled by putting the shaft, the retaining buckle, and the control unit together; (iii) the drainage port and water through hole are connected simply with the shaft without any reduction on waterway, so the volume of water outflow will not be reduced.

### BRIEF DESCRIPTION OF THE DRAWINGS

FIG. 1 illustrates a three-dimensional view of the present invention.

FIG. 2 illustrates an exploded view of the present invention.

FIG. 3 illustrates another exploded view of the present invention.

FIG. 4 illustrates a sectional view of the present invention.

FIG. 5 illustrates a sectional view from another angle of the present invention.

FIG. 6 illustrates a schematic view of the present invention when the water is on.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

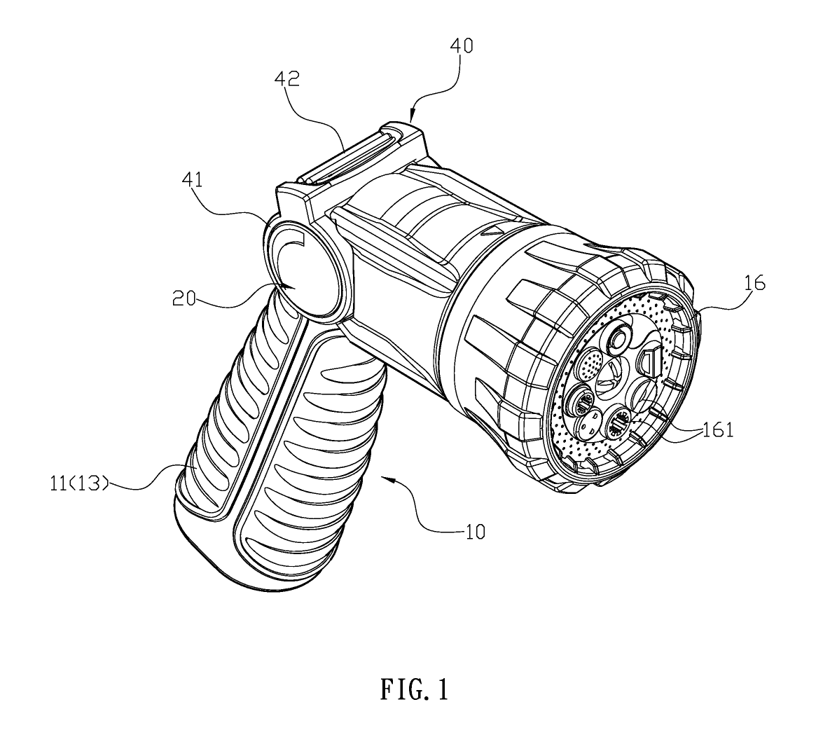

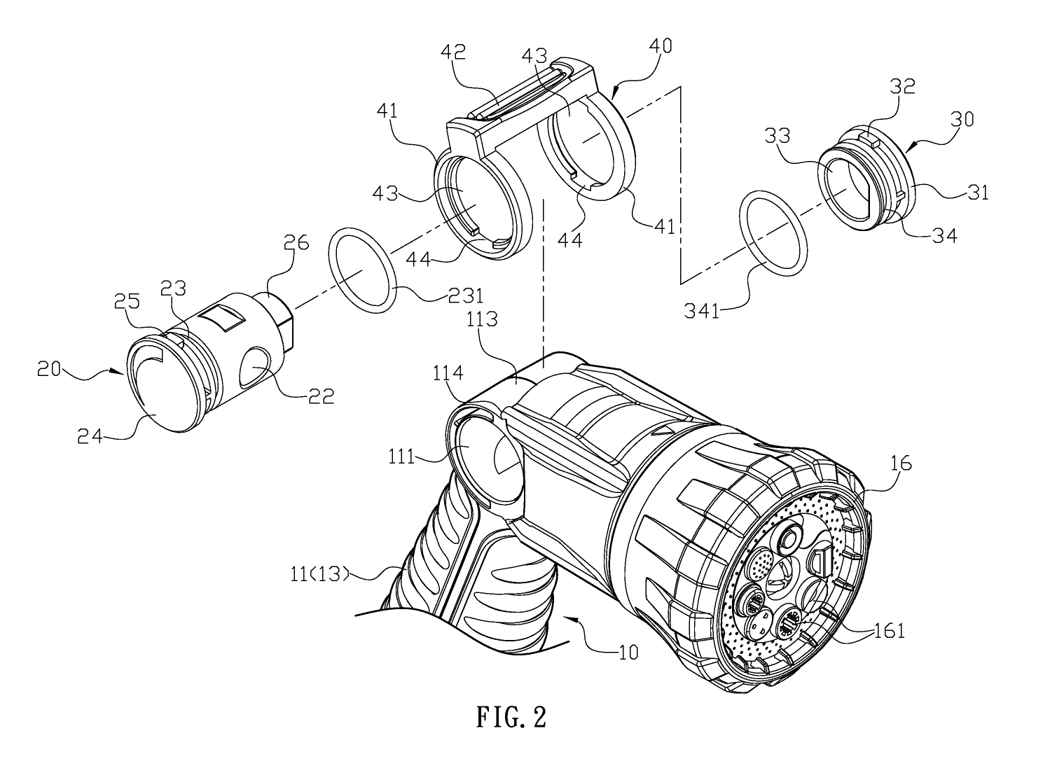

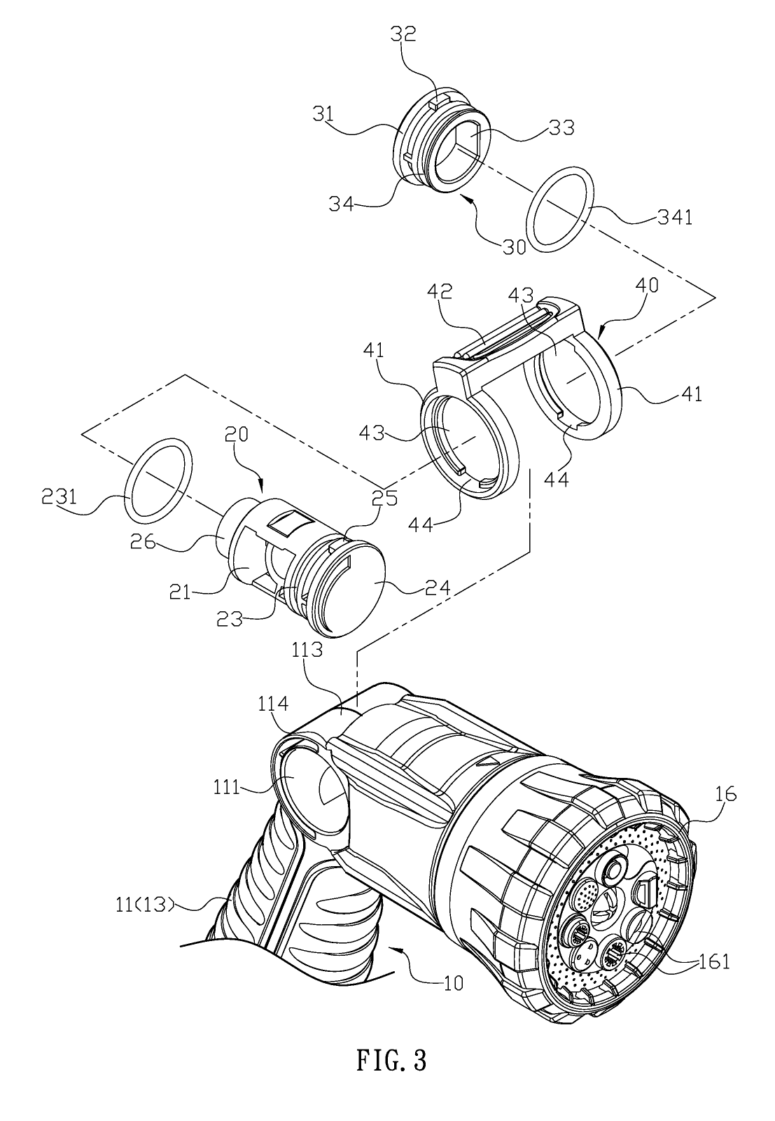

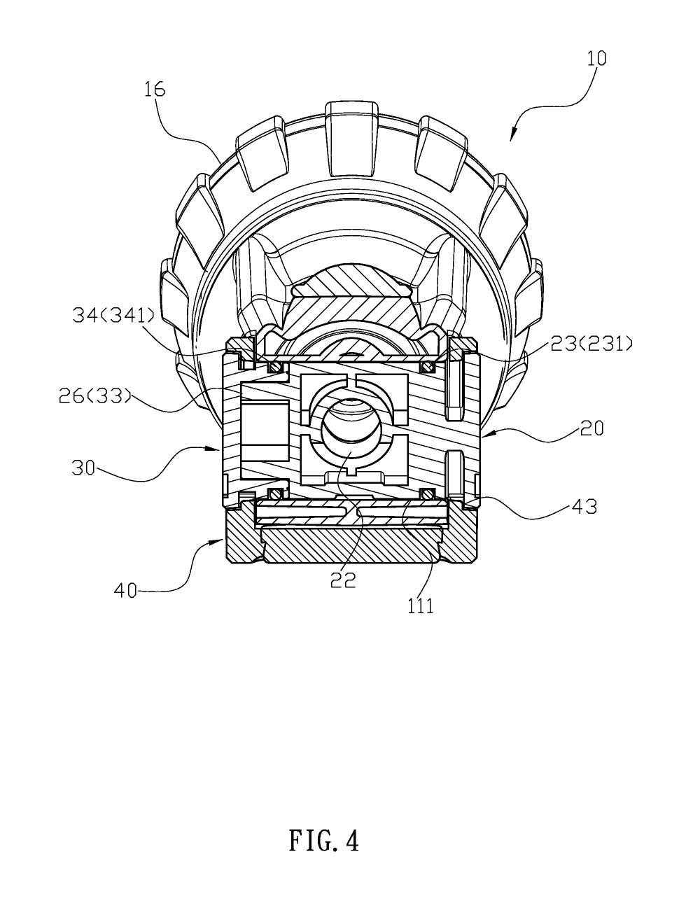

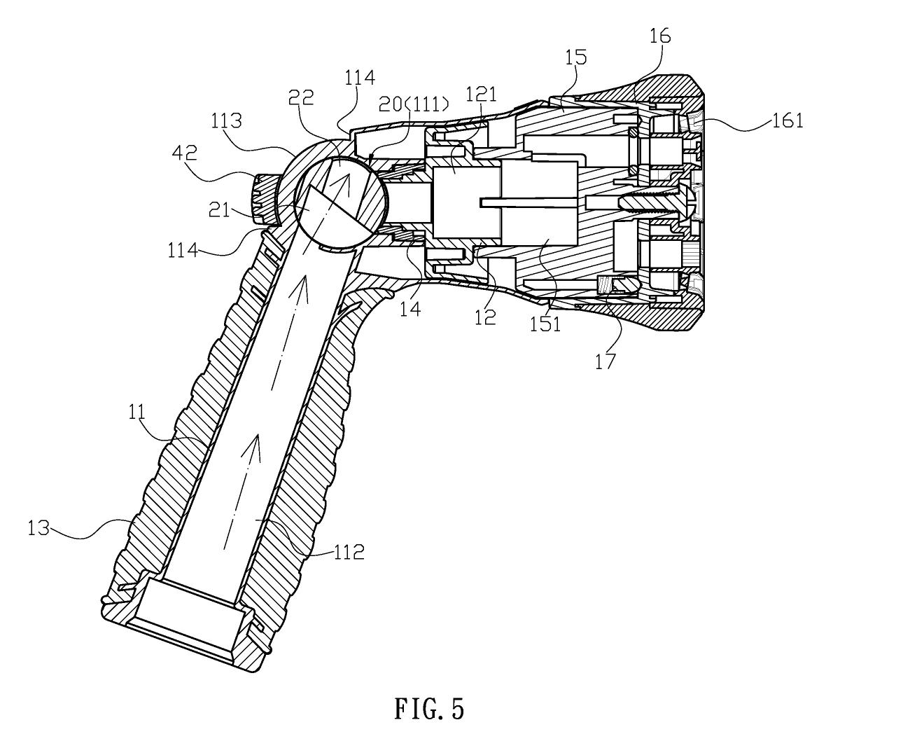

Referring to FIGS. 1 through 5, a gardening spray gun may include a main body (10), a shaft (20), a retaining buckle (30), and a control unit (40). The main body (10) has a handle (11), and a barrel portion (12) which connects with the handle (11). The handle (11) is covered with a protection cover (13). With an anti-leaking unit (14) in between the handle (11) and barrel portion (12), the handle (11) and barrel portion (12) can be brought together tightly to achieve an anti-leaking effect. At a front end of the barrel portion (12), there is a water flowing hole (151) located at one side of a sprinkler base (15) connected to a sprinkler head (16). The handle (11) has a water control space (111) located at a top corner thereof, and the water control space (111) is communicated with an inlet conduit (112) of the handle (11), an outlet conduit (121) of the barrel portion (12), and the water flowing hole (151) of the sprinkler base (15). A curved guiding surface (113) is formed at outer periphery of the water control space (111) and both side of the guiding surface (113) has a retaining rib (114). On the sprinkler head (16), there are sprinkler holes (161) used to control of water flow in various manners. There is a positioning device (17) with a spring and a pillar located between the sprinkler base (15) and sprinkler head (16).

There is a drainage port (21) located at a side corner of a shaft (20) with a suitable angle. A water through hole (22) is located at the bottom of the drainage port (21), going through other opposite side through the shaft (20). When the water through hole (22) is shaded with different degrees, it can be utilized to control water flow and turn the water on or off. A sealing ring (231) covered onto a ring groove (23) is located on one side of the shaft (20), and a smaller joint tube (26) is extending toward the other side thereof. The ring groove (23) is extending outwardly connected with a stopping edge (24), and a block (25) protrudes out from both sides of the stopping edge (24). In one embodiment, the joint tube (26) is non-circular.

A retaining buckle (30) has an enlarged ledge (31) at one end, a connecting hole (33) shaped similar as the joint tube (26) located at the other end. A stopping block (32) are protrudingly formed at an inner surface on both sides of the enlarged ledge (31). A sealing ring (341) covered onto a ring groove (34) is located outside of the retaining buckle (30). The control unit (40) has two spiral arms (41) and a connecting block (42) located in between. There is a ladder-shaped hole (43) located at the spiral arm (41), and a engaging slot (44) is recessedly formed in the ladder-shaped hole (43).

Referring to FIGS. 1, 4, and 5, a control unit (40) has two spiral arms (41) lining against the outer portion of the water control space (111) to enable the connecting block (42) to align with the guiding surface (113), so it can move with a limited degree on the guided surface (113). When a joint tube (26) of the shaft (20) is inserted from the ladder-shaped hole (43) of one spiral arm (41) through the water control space (111), it further extends towards the other side, so the connecting hole (33) of the retaining buckle (30) can engage with the joint tube (26). Furthermore, the stopping edge (24) and the enlarged edge (31) can be both disposed in the ladder-shaped hole (43), so the block (25) and the stopping block (32) can also be disposed into the engaging slot (44) of the control unit (40), to complete the assembly process of the control unit (40), the shaft (20) and the retaining buckle (30).

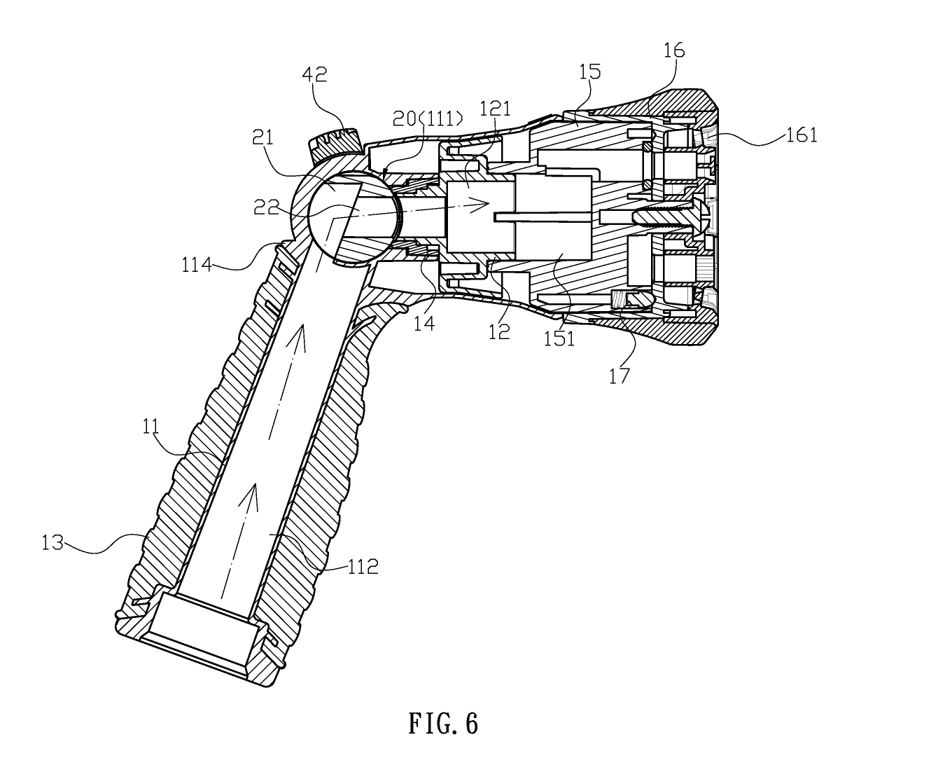

When in use, a hose is connected to the inlet conduit (112) at the handle (11) so that water source can flow into this inlet conduit (112) towards the water control space (111). When the water is received from the drainage port (21) with the shaft (20) and delivered toward the water through hole (22), the water may flow towards the outlet conduit (121) through the water flowing hole (151) of the sprinkler base (15) towards the sprinkler holes (161) of the sprinkler head (16), which can either be utilized for gardening spray or for washing and cleaning purpose. While water outflow in progress, the sprinkler head (16) can still be adjusted for different formats of water output. When the user wishes to adjust volume on the water output, or to stop completely (see FIG. 6), he/she can simply use the finger to control the connecting block (42), so the connecting block (42) can swing within a limited degree between two retaining ribs (114). Through the engagement of the block (25) and the stopping block (32) in the engaging slot (44), the shaft (20) and the retaining buckle (30) will move with the control unit (40). Also, due to the misalignment between the water through hole (22) and the outlet conduit (121), the inner wall of the water control space (111) is used to shade the water through hole (22) with different degrees. As the result, the water output can be adjusted, and if the user wishes to resume, he/she can simply just activate the connecting block (42) with the finger.

According to the embodiments discussed above, the present invention is advantageous because (i) the control unit (40) is connected with the shaft (20), so the water coutput can be continuously maintained out without keeping a constant pressure on the spray gun, which saves the gardener's energy, effectively reduces the hand burden, and maintains a stable water outflow volume each and every time; (ii) the water spray gun can be easily assembled by putting the shaft (20), the retaining buckle (30), and the control unit (40) together; (iii) the drainage port (21) and water through hole (22) are connected simply with the shaft (20) without any reduction on waterway, so the volume of water outflow will not be reduced.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening spray gun comprising a main body, a shaft, a retaining buckle, and a control unit,
wherein the main body has a handle, and a barrel portion which connects with the handle, and the handle is covered with a protection cover; and the handle and barrel portion are brought together tightly to achieve an anti-leaking effect with an anti-leaking unit therebetween, wherein at a front end of the barrel portion, a water flowing hole is located at one side of a sprinkler base connected to a sprinkler head, and the handle has a water control space located at a top corner thereof, and the water control space is communicated with an inlet conduit of the handle, an outlet conduit of the barrel portion, and the water flowing hole of the sprinkler base, wherein a curved guiding surface is formed at outer periphery of the water control space and both side of the guiding surface has a retaining rib, and a plurality of sprinkler holes used to control of water flow in various manners are formed on the sprinkler head,
wherein a drainage port is located at a side corner of a shaft with a suitable angle, and a water through hole is located at the bottom of the drainage port, going through other opposite side through the shaft, wherein when the water through hole is shaded with different degrees, it can be utilized to control water flow and turn the water on or off, and a sealing ring covered onto a ring groove is located on one side of the shaft, and a smaller joint tube is extending toward the other side thereof, wherein the ring groove is extending outwardly connected with a stopping edge, and a block protrudes out from both sides of the stopping edge,
wherein the retaining buckle has an enlarged ledge at one end, a connecting hole shaped similar as the joint tube located at the other end, and a stopping block is protrudingly formed at an inner surface on both sides of the enlarged ledge, and a sealing ring covered onto a ring groove is located outside of the retaining buckle,
wherein the control unit has two spiral arms and a connecting block located in between, and a ladder-shaped hole located at the spiral arm, and a engaging slot is recessedly formed in the ladder-shaped hole.

2. The gardening spray gun of claim 1, wherein a positioning device with a spring and a pillar is located between the sprinkler base and sprinkler head.

3. The gardening spray gun of claim 1, wherein the joint tube is of a non-circular shape.
